(19) United States
(12) Patent Application Publication
(10) Pub. No.: US 2023/0132788 A1
(43) Pub. Date: May 4, 2023

(54) COIL COMPONENT AND METHOD OF MANUFACTURING THE SAME

(71) Applicant: SAMSUNG ELECTRO-MECHANICS CO., LTD., Suwon-si (KR)

(72) Inventor: Hyun Kyu IM, Suwon-si (KR)

(73) Assignee: SAMSUNG ELECTRO-MECHANICS CO., LTD., Suwon-si (KR)

(21) Appl. No.: 17/957,024

(22) Filed: Sep. 30, 2022

(30) Foreign Application Priority Data
Oct. 29, 2021 (KR) 10-2021-0146449

(51) Int. Cl. H01F 27/29; H01F 27/32; H01F 41/12

(52) U.S. Cl. CPC H01F 27/29; H01F 27/32; H01F 41/125

(57) ABSTRACT

A coil component includes a body including one surface and a plurality of side surfaces respectively connected to the one surface, a coil portion disposed within the body, and a lead-out portion disposed within the body and connected to the coil portion. The body includes a groove portion disposed in a corner where two adjacent side surfaces of the plurality of side surfaces of the body are in contact with each other. The groove portion has a width narrower than a width of the body, and extends from a portion of the lead-out portion.

### CROSS-REFERENCE TO RELATED APPLICATION(S)

This application claims benefit of priority to Korean Patent Application No. 10-2021-0146449 filed on Oct. 29, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in an electronic device together with a resistor and a capacitor.

As the electronic device implements high-performance and has a smaller size, the electronic component used in the electronic device may have increased numbers and a smaller size.

In recent years, mainly used as the inductor is a bottom-electrode type product in which all five surfaces of the coil component are insulated except for a region of a bottom electrode, which leads to an increasing development of a new bottom-electrode type product.

In order to manufacture the bottom-electrode type product in which the electrodes are formed only in one direction, research is continued to solve a problem in which defects frequently occur due to a singularity occurring in a structure of a product.

### SUMMARY

An aspect of the present disclosure may provide a coil component including a microcircuit pattern, which may be mounted on a board.

Another aspect of the present disclosure may provide a coil component including a coil with less loss of a magnetic metal.

According to an aspect of the present disclosure, a coil component may include: a body including one surface and a plurality of side surfaces respectively connected to the one surface; a coil portion disposed within the body; and a lead-out portion disposed within the body and connected to the coil portion. The body may include a groove portion disposed in a corner where two adjacent side surfaces of the plurality of side surfaces of the body are in contact with each other. The groove portion may have a width narrower than a width of the body, and extend from a portion of the lead-out portion.

According to another aspect of the present disclosure, a manufacturing method of a coil component may include: preparing forming a coil bar on which a magnetic sheet covering each of a coil portion and a lead-out portion connected to each other is stacked; forming at least one groove portion in one surface of the coil bar; and preparing a body including one surface and the other surface opposing each other in a thickness direction by routing the coil bar along a plurality of routing lines to expose at least a portion of the lead-out portion. The groove portion may be formed in a region where the plurality of routing lines intersect each other.

According to another aspect of the present disclosure, a coil component may include: a body including one surface and a plurality of side surfaces respectively connected to the one surface; a coil portion disposed within the body; a lead-out portion disposed within the body and connected to the coil portion; and an external electrode disposed on the body. The body may include a groove portion extending from the one surface and one or more of the plurality of side surfaces to a portion of the lead-out portion. The groove portion may have a width narrower than a width of the body and is filled with an insulating material. The external electrode may be connected to the lead-out portion through a conductive layer disposed on a surface of the groove portion and connected to the lead-out portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a coil component according to the present disclosure;

FIG. 2 is a perspective view of another coil component according to the present disclosure;

FIG. 3 is a cross-sectional view taken along line I-I′ of FIG. 1;

FIG. 4 is a cross-sectional view taken along line II-II′ of FIG. 2;

FIG. 5 is a perspective view of yet another coil component according to the present disclosure;

FIG. 6 is a perspective view of still another coil component according to the present disclosure; and

FIGS. 7A through 7C are views schematically illustrating a manufacturing method of a coil component according to the present disclosure.

### DETAILED DESCRIPTION

Hereinafter, exemplary embodiments in the present disclosure will now be described in detail with reference to the accompanying drawings.

In the drawings, a T direction refers to a first direction or a thickness direction, a W direction refers to a second direction or a width direction, and an L direction refers to a third direction or a length direction.

Hereinafter, a coil component according to exemplary embodiments of the present disclosure will be described in detail with reference to the accompanying drawings. In describing exemplary embodiments of the present disclosure with reference to the accompanying drawings, components that are the same as or correspond to each other will be denoted by the same reference numerals, and overlapping descriptions thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter or the like.

### Coil Component

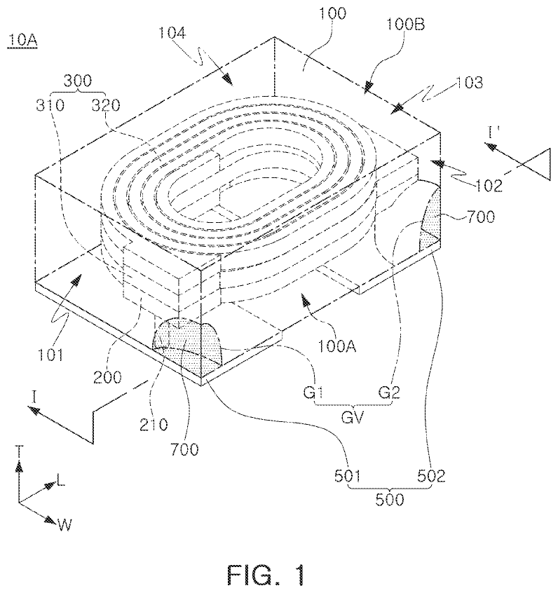

FIG. 1 is a perspective view of a coil component according to the present disclosure.

Referring to the drawing, a coil component 10A according to an exemplary embodiment of the present disclosure may include: a body 100 including one surface 100A and the other surface 100B opposing the one surface 100A and first to fourth side surfaces 101, 102, 103 and 104 respectively connected to the one surface 100A and adjacent to each other; and a lead-out portion 200 disposed within the body 100. The body may include a groove portion GV disposed in the one surface 100A of the body by having a length in the width (W) direction shorter than a length of the body 100 in the width (W) direction, and exposing at least a portion of the lead-out portion 200.

In addition, the lead-out portion 200 may include a connection portion 210 in contact with at least a portion of the one surface 100A of the body, and is not limited thereto. In more detail, an external electrode 500 described below may be in direct contact with the lead-out portion 200 or in contact with the connection portion 210 of the lead-out portion 200, and is not limited thereto.

The groove portion GV of the coil component 10A according to the present disclosure may include first and second groove portions G1 and G2 respectively disposed in two opposite ends of the second side surface 102 of the body in the length direction, while being spaced apart from each other, and respectively extended to the first and third side surfaces 101 and 103 of the body, adjacent to the second side surface 102. Here, the lead-out portion 200 may be formed close to the groove portion GV in the first side surface 101 of the body to be exposed from the groove portion GV.

In addition, the groove portion GV may have a length shorter than a length of the body 100, based on a thickness (T) direction of the coil component 10A according to the present disclosure. That is, the groove portion GV may not entirely pass through the body in the thickness (T) direction, and is not limited thereto.

Here, the groove portion GV may be extended to each of two side surfaces adjacent to each other among the first to fourth side surfaces 101 to 104 of the body, and is not limited thereto.

In addition, the groove portion GV may include a first region R1 formed in the one surface 100A of the body and a second region R2 having a greatest distance from the one surface 100A of the body in the thickness (T) direction, and the first region R1 of the groove portion GV may have a size such as a diameter larger than a size such as a diameter of the second region R2 of the groove portion. That is, the groove portion GV may become narrower toward the inside of the body 100, and is not limited thereto.

The groove portion GV may have a tapered shape, and it is thus possible to reduce loss of the body 100 including a magnetic material described below, and to reduce occurrence of defective products by exposing the lead-out portion 200.

In addition, the coil component 10A according to the present disclosure may further include a coil portion 300 disposed within the body 100 and connected to the lead-out portion 200 and an insulating layer 400 covering the coil portion 300, and at least a portion of the insulating layer 400 may be exposed to the groove portion GV.

In addition, the coil portion 300 of the coil component 10A according to the present disclosure may include a board 310 and a coil pattern 320 disposed on each of one surface and the other surface of the board. That is, the coil component may be a thin-film type coil component.

Here, the coil pattern 320 may be disposed on each of the upper and lower portions of the board 310, and a via may pass through the board 310 to connect the coil patterns disposed on the upper and lower portions thereof, and is not limited thereto.

In addition, at least a portion of the board 310 may be exposed to each of two side surfaces of the body 100, opposing each other, and is not limited thereto.

Here, the insulating layer 400 may function to insulate the body 100 and the coil pattern 320 from each other, and is not limited thereto. In addition, the insulating layer 400 may be extended to cover the board 310.

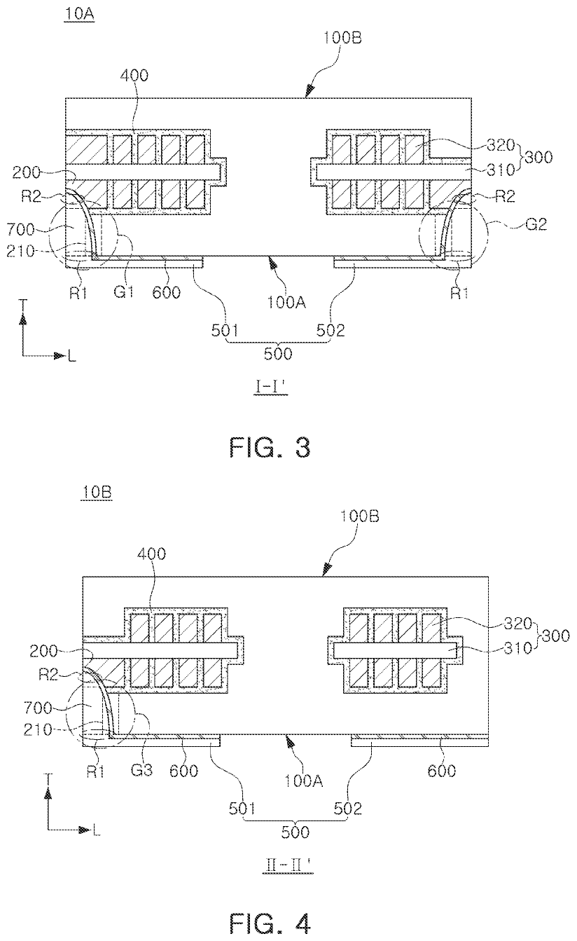

In addition, the coil component 10A according to the present disclosure may further include a plating layer 600 disposed on at least a portion of each of the one surface 100A and the groove portion GV of the body and in contact with at least a portion of the exposed lead-out portion 200, first and second external electrodes 501 and 502 each in contact with at least a portion of the plating layer 600, and disposed on the one surface 100A of the body, while being spaced apart from each other, and an insulating material 700 (700 is omitted in FIG. 1 and is shown in FIG. 3) disposed in the groove portion GV and in contact with at least a portion of the plating layer 600. Here, the insulating material 700 may be extended to at least one of the first to fourth side surfaces 101 to 104 of the body, and is not limited thereto. In addition, each of the first and second external electrodes 501 and 502 may be extended to the two side surfaces of the body 100, opposing each other.

The insulating material 700 may cover five surfaces of the body except for the other surface 100B, thus forming the coil component 10A including a bottom electrode which is the electrode disposed only in one direction.

The body 100 may form an appearance of the coil component 10A according to this exemplary embodiment, and may embed the coil portion 300 therein. The body 100 may generally have a hexahedral shape.

The body 100 may include the magnetic material and an insulating resin. In detail, the body 100 may be formed by stacking at least one magnetic composite sheet including the insulating resin and the magnetic materials dispersed in the insulating resin. However, the body 100 may have a structure other than a structure in which the magnetic materials are dispersed in the insulating resin. For example, the body 100 may be made of the magnetic material such as ferrite.

The magnetic material may be ferrite or metal magnetic powder particles.

The ferrite powder particles may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite; a hexagonal type ferrite such as Ba—Zn-based ferrite, Ba—Mg-based ferrite, Ba—Ni-based ferrite, Ba—Co-based ferrite or Ba—Ni—Co-based ferrite; and a garnet type ferrite such as Y-based ferrite or Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles and Fe—Cr—Al-based alloy powder particles.

The metal magnetic powder particles may be amorphous or crystalline. For example, the metal magnetic powder particles may be Fe—Si—B—Cr based amorphous alloy powder particles, and are not necessarily limited thereto.

The ferrite and the metal magnetic powder particles may have average diameters of about 0.1 μm to 30 μm, respectively, and are not limited thereto.

The body 100 may include two or more types of magnetic materials dispersed in the insulating resin. Here, different types of magnetic materials may indicate that the magnetic materials dispersed in the insulating resin are distinguished from each other by any one of an average diameter, a composition, crystallinity and a shape.

The insulating resin may include epoxy, polyimide, liquid crystal polymer (LCP) or the like, or a mixture thereof, and is not limited thereto.

The lead-out portion 200 and the coil portion 300 may each be embedded in the body 100. The coil portion 300 may exhibit a characteristic of the coil component according to the present disclosure. For example, when the coil component of this exemplary embodiment is used as a power inductor, the coil portion 300 may serve to store an electric field as a magnetic field to maintain an output voltage, thereby stabilizing power of the electronic device. Here, the coil portion 300 may not be limited to a thin-film coil, and may be a wound-type coil or a stacked-type coil.

Each of the coil pattern 320 of the coil portion, the lead-out portion 200 and the via may be formed of a conductive material such as copper (Cu), aluminum (Al), silver (Ag), tin (Sn), gold (Au), nickel (Ni), lead (Pb), titanium (Ti) or an alloy thereof, and is not limited thereto.

The board 310 of the coil portion may be formed of an insulating material including a thermosetting insulating resin such as an epoxy resin, a thermoplastic insulating resin such as polyimide or a photosensitive insulating resin, or an insulating material impregnated with a reinforcing material such as a glass fiber or inorganic filler in the insulating resin. For example, the board 310 may be formed of the insulating material such as a copper clad laminate (CCL), an unclad CCL, prepreg, an Ajinomoto build-up film (ABF), FR-4, a bismaleimide triazine (BT) film or a photo imagable dielectric (PID) film, and is not limited thereto.

The inorganic filler may use one or more materials selected from the group consisting of silica (SiO₂), alumina (Al₂O₃), silicon carbide (SiC), barium sulfate (BaSO₄), talc, clay, mica powder particles, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

When formed of the insulating material including the reinforcing material, the board 310 may provide higher rigidity. The board 310 may be formed of the insulating material not including the glass fiber, which may be advantageous because the coil portion 300 may have an increased volume in the body 100 having the same size.

When the board 310 is formed of the insulating material including the photosensitive insulating resin, it is possible to reduce the number of processes of forming the coil portion 300, which may be advantageous in reducing a production cost and forming a fine via.

A metal included in the external electrode 500 having the first and second external electrodes 501 and 502 may each be made of an alloy of two or more selected from the group consisting of tin (Sn), lead (Pb), indium (In), copper (Cu), silver (Ag) and bismuth (Bi).

The external electrode 500 may be formed by applying a conductive resin paste or may be formed by plating a material including the metal material, and is not limited thereto.

The insulating layer 400 surrounding the coil portion 300 may be formed by using at least one of a vapor deposition method and a film lamination method. Meanwhile, the insulating layer 400 formed by using the latter method may be a permanent resist in which a plating resist used in plating the coil portion 300 on the board 310 remains in a final product, and is not limited thereto.

In addition, the external electrode 500 may further include a plating layer. Here, the plating layer may include the conductive material. The plating layer may be electrically connected to a solder, which is a connecting conductor. Here, the plating layer may include nickel (Ni) or tin (Sn), and may have a structure in which a nickel (Ni) plating layer and a tin (Sn) plating layer are sequentially stacked. When the external electrode is a conductive resin layer, the nickel (Ni) plating layer may be in contact with the conductive connection portion and base resin of the conductive resin layer in the external electrode 500.

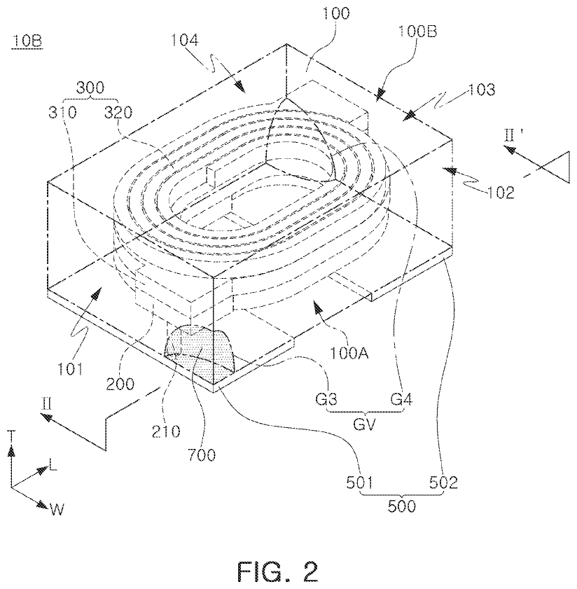

FIG. 2 is a perspective view of another coil component according to the present disclosure.

Referring to the drawing, a groove portion GV of a coil component 10B according to another exemplary embodiment of the present disclosure may include a third groove portion G3 extended to the first and second side surfaces 101 and 102 of the body, adjacent to each other, and a fourth groove portion G4 extended to the third and fourth side surfaces 103 and 104 of the body, adjacent to each other. Here, the third and fourth groove portions G3 and G4 may be spaced apart from each other, and are not limited thereto. In addition, the third and fourth groove portions G3 and G4 may each have a length in the thickness (T) direction shorter than a length of the body 100 in the thickness (T) direction.

The groove portion GV of the coil component 10B according to the present disclosure may include the third groove portion G3 formed in a region where the one surface 100A of the body and the first and second side surfaces 101 and 102 of the body meet one another, and the fourth groove portion G4 formed in a region where the one surface 100A of the body and the third and fourth side surfaces 103 and 104 of the body meet one another. Here, the lead-out portion 200 may be formed close to the groove portion GV in the first and third side surfaces 101 and 103 of the body to be exposed from the third and fourth groove portions G3 and G4, and is not limited thereto.

In addition, the groove portion GV may have the length shorter than the length of the body 100, based on the thickness (T) direction of the coil component 10B according to the present disclosure. That is, the groove portion GV may not entirely pass through the body in the thickness (T) direction, and is not limited thereto.

Here, the groove portion GV may be extended to each of two side surfaces adjacent to each other among the first to fourth side surfaces 101 to 104 of the body, and is not limited thereto.

In addition, the groove portion GV may become narrower toward the inside of the body 100, and is not limited thereto.

The groove portion GV may have a tapered shape, and it is thus possible to reduce loss of the body 100 including a magnetic material, and to reduce occurrence of defective products by exposing the lead-out portion 200.

Descriptions of the other components are substantially the same as those described above, and detailed descriptions thereof are thus omitted.

FIG. 3 is a cross-sectional view taken along line I-I′ of FIG. 1. Here, the line I-I′ of FIG. 1 may cross each of the first and second groove portions G1 and G2 of the groove portion GV.

Referring to the drawing, the coil component 10A according to an exemplary embodiment of the present disclosure may include the body 100, the lead-out portion 200 and the coil portion 300 disposed within the body, the plating layer 600 disposed on each of the one surface 100A of the body and the groove portion GV, the insulating material 700 maintaining the hexahedral shape of the body 100 by filling the groove portion GV, and the external electrode 500 disposed on the one surface 100A of the body and connected to the plating layer 600.

Here, at least a portion of the lead-out portion 200 may be exposed to the groove portion GV, and the exposed lead-out portion 200 may be in contact with the plating layer 600. In addition, the lead-out portion 200 may include the connection portion 210 having at least a portion exposed to the groove portion GV to be in contact with least one of the plating layer 600 and the external electrode 500, and is not limited thereto.

In addition, the groove portion GV of the coil component 10A according to the present disclosure may include the first region R1 formed in the one surface 100A of the body and the second region R2 having the greatest distance from the one surface 100A of the body in the thickness (T) direction, and the first region R1 of the groove portion GV may have the size such as the diameter larger than the size such as the diameter of the second region R2 of the groove portion. That is, the groove portion GV may become narrower toward the inside of the body 100, and is not limited thereto.

The groove portion GV may have the tapered shape, and it is thus possible to reduce the loss of the body 100 including the magnetic material, and to reduce the occurrence of the defective products by exposing the lead-out portion 200.

Descriptions of the other components are substantially the same as those described above, and detailed descriptions thereof are thus omitted.

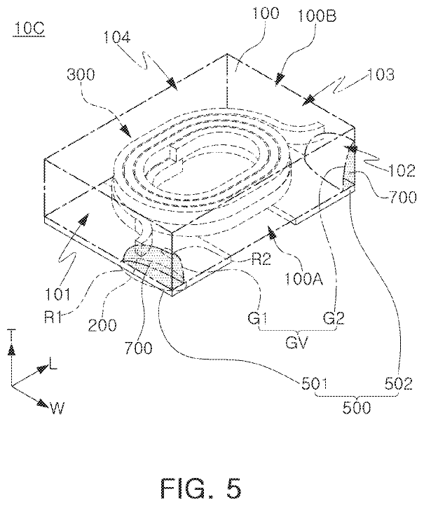

FIG. 4 is a cross-sectional view taken along line II-II′ of FIG. 2. Here, the line II-II′ of FIG. 2 may cross at least one of the third and fourth groove portions G3 and G4 of the groove portion GV.

Referring to the drawing, the coil component 10B according to another exemplary embodiment of the present disclosure may include the body 100, the lead-out portion 200 and the coil portion 300 disposed within the body, the plating layer 600 disposed on each of the one surface 100A of the body and the groove portion GV, the insulating material 700 maintaining the body 100 to have the hexahedral shape by filling the groove portion GV, and the external electrode 500 disposed on the one surface 100A of the body and connected to the plating layer 600.

Here, at least a portion of the lead-out portion 200 may be exposed to the groove portion GV, and the exposed lead-out portion 200 may be in contact with the plating layer 600. In addition, the lead-out portion 200 may include the connection portion 210 having at least a portion exposed to the groove portion GV to be in contact with least one of the plating layer 600 and the external electrode 500, and is not limited thereto.

In addition, the groove portion GV of the coil component 10B according to the present disclosure may include the first region R1 formed in the one surface 100A of the body and the second region R2 having the greatest distance from the one surface 100A of the body in the thickness (T) direction, and the first region R1 of the groove portion GV may have the size such as the diameter larger than the size such as the diameter of the second region R2 of the groove portion. That is, the groove portion GV may become narrower toward the inside of the body 100, and is not limited thereto.

The groove portion GV may have the tapered shape, and it is thus possible to reduce the loss of the body 100 including the magnetic material, and to reduce the occurrence of the defective products by exposing the lead-out portion 200.

Descriptions of the other components are substantially the same as those described above, and detailed descriptions thereof are thus omitted.

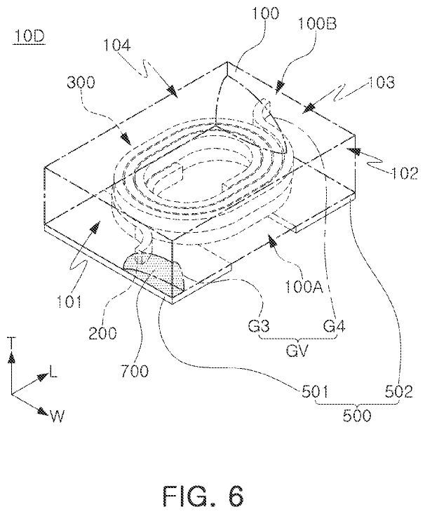

FIG. 5 is a perspective view of yet another coil component according to the present disclosure.

Referring to the drawing, a coil component 10C according to yet another exemplary embodiment of the present disclosure may include: a body 100 including one surface 100A and the other surface 100B opposing the one surface 100A and first to fourth side surfaces 101, 102, 103 and 104 respectively connected to the one surface 100A and adjacent to each other; and a lead-out portion 200 disposed within the body 100. The body may include a groove portion GV disposed in the one surface 100A of the body by having a length in the width (W) direction shorter than a length of the body 100 in the width (W) direction, and exposing at least a portion of the lead-out portion 200.

The groove portion GV of the coil component 10C according to the present disclosure may include first and second groove portions G1 and G2 respectively disposed in two opposite ends of the second side surface 102 of the body in the length direction, while being spaced apart from each other, and respectively extended to the first and third side surfaces 101 and 103 of the body, adjacent to the second side surface 102. Here, the lead-out portion 200 may be formed close to the groove portion GV in the first side surface 101 of the body to be exposed from the groove portion GV.

In addition, the groove portion GV may have a length shorter than a length of the body 100, based on the thickness (T) direction of the coil component 10C according to the present disclosure. That is, the groove portion GV may not entirely pass through the body in the thickness (T) direction, and is not limited thereto.

Here, the groove portion GV may be extended to each of two side surfaces adjacent to each other among the first to fourth side surfaces 101 to 104 of the body, and is not limited thereto.

In addition, the groove portion GV may include a first region R1 formed in the one surface 100A of the body and a second region R2 having a greatest distance from the one surface 100A of the body in the thickness (T) direction, and the first region R1 of the groove portion GV may have a size such as a diameter larger than a size such as a diameter of the second region R2 of the groove portion. That is, the groove portion GV may become narrower toward the inside of the body 100, and is not limited thereto.

The groove portion GV may have a tapered shape, and it is thus possible to reduce loss of the body 100 including a magnetic material described below, and to reduce occurrence of defective products by exposing the lead-out portion 200.

In addition, the coil portion 300 of the coil component 10C according to the present disclosure may be a wound-type coil, and is not limited thereto. Here, the coil portion 300 may be embedded in the body 100, and include two coil patterns 320 at least some of which are in contact with each other.

In addition, the coil component 10C according to the present disclosure may further include a plating layer 600 (see 600 shown in FIG. 3 or FIG. 4) disposed on at least a portion of each of the one surface 100A and the groove portion GV of the body and in contact with at least a portion of the exposed lead-out portion 200, first and second external electrodes 501 and 502 each in contact with at least a portion of the plating layer 600, and disposed on the one surface 100A of the body, while being spaced apart from each other, and an insulating material 700 (700 is omitted in FIG. 5 and its corresponding structure may be referred to FIG. 3 or FIG. 4) disposed in the groove portion GV and in contact with at least a portion of the plating layer 600. Here, the insulating material 700 may be extended to at least one of the first to fourth side surfaces 101 to 104 of the body, and is not limited thereto. In addition, each of the first and second external electrodes 501 and 502 may be extended to two side surfaces of the body 100, opposing each other.

The insulating material 700 may cover five surfaces of the body except for the other surface opposing the one surface 100A in the thickness direction, thus forming the coil component 10A including a bottom electrode which is the electrode disposed only in one direction.

Descriptions of the other components are substantially the same as those described above, and detailed descriptions thereof are thus omitted.

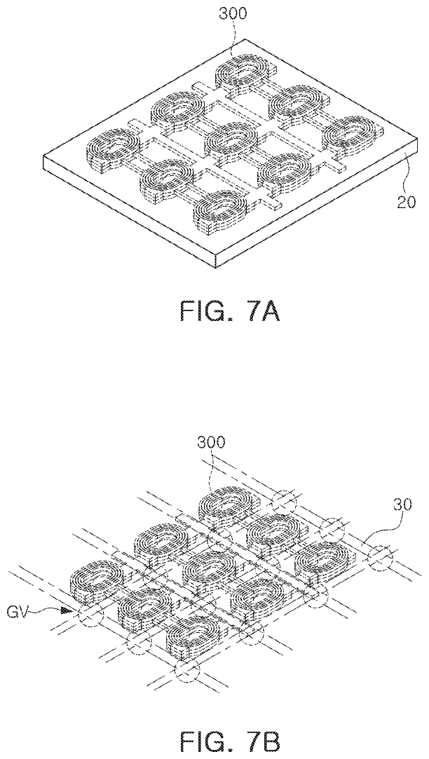

FIG. 6 is a perspective view of still another coil component according to the present disclosure.

Referring to the drawing, a groove portion GV of a coil component 10D according to still another exemplary embodiment of the present disclosure may include a third groove portion G3 extended to the first and second side surfaces 101 and 102 of the body, adjacent to each other, and a fourth groove portion G4 extended to the third and fourth side surfaces 103 and 104 of the body, adjacent to each other. Here, the third and fourth groove portions G3 and G4 may be spaced apart from each other, and are not limited thereto. In addition, the third and fourth groove portions G3 and G4 may each have a length in the thickness (T) direction shorter than a length of the body 100 in the thickness (T) direction.

The groove portion GV of the coil component 10D according to the present disclosure may include the third groove portion G3 formed in a region where the one surface 100A of the body and the first and second side surfaces 101 and 102 of the body meet one another, and the fourth groove portion G4 formed in a region where the one surface 100A of the body and the third and fourth side surfaces 103 and 104 of the body meet one another. Here, the lead-out portion 200 may be formed close to the groove portion GV in the first and third side surfaces 101 and 103 of the body to be exposed from the third and fourth groove portions G3 and G4, and is not limited thereto.

In addition, the groove portion GV may have the length shorter than the length of the body 100, based on the thickness (T) direction of the coil component 10D according to the present disclosure. That is, the groove portion GV may not entirely pass through the body in the thickness (T) direction, and is not limited thereto.

Here, the groove portion GV may be extended to each of two side surfaces adjacent to each other among the first to fourth side surfaces 101 to 104 of the body, and is not limited thereto.

In addition, the groove portion GV may become narrower toward the inside of the body 100, and is not limited thereto.

The groove portion GV may have a tapered shape, and it is thus possible to reduce loss of the body 100 including a magnetic material described below, and to reduce occurrence of defective products by exposing the lead-out portion 200.

Descriptions of the other components are substantially the same as those described above, and detailed descriptions thereof are thus omitted.

### Manufacturing Method of Coil Component

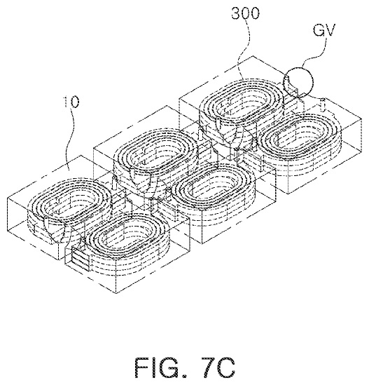

FIGS. 7A through 7C are views schematically illustrating a manufacturing method of a coil component according to the present disclosure.

As shown in FIG. 7A, first prepared is a coil bar which is formed by connecting a plurality of coils connected to each other and on which a magnetic sheet is stacked. Here shown is that the coil bar is disposed on a board 310, and the present disclosure is not limited thereto.

The following is a specific method of preparing the coil bar.

A plurality of coil patterns 320 may be formed on an insulation board. The insulation board may not be particularly limited, may be formed of at least one of a copper clad laminate, a prepreg (PPG), an Ajinomoto build-up film (ABF) and a photo imagable dielectric (PID) for example, and may have a thickness of 20 to 100 μm.

The coil pattern 320 may be formed by using, for example, an electroplating method, and is not limited thereto. The coil pattern 320 may be formed of a metal having excellent electrical conductivity, for example, silver (Ag), palladium (Pd), aluminum (Al), nickel (Ni), titanium (Ti), gold (Au), copper (Cu), platinum (Pt) or an alloy thereof.

A via may be formed by forming a via hole in a portion of the insulation board and then filling the via hole with a conductive material, and may electrically connect the coil patterns 320 respectively formed on one surface and the other surface of the insulation board to each other.

The coil pattern 320 may be connected to the lead-out portion 200 exposed to each of first and third side surfaces 101 and 103 of a body 100 after being diced. Respective both ends of adjacent coil patterns 320 in a state of the coil bar before being diced may be physically and electrically connected to each other.

A portion where the coil pattern 320 is not formed may then be removed from the insulation board.

The corresponding portion may be removed from the insulation board by using mechanical drilling, laser drilling, sand blasting, punching processing or the like, and may be removed by using a carbon dioxide (CO₂) laser drill for example.

A through-hole passing through the insulation board may be formed by removing a central region of the insulation board, where the coil pattern 320 is not formed.

Here, it is possible not to remove a portion of the insulation board, where the coil portion 300 is not formed, and to remove only the rest, to form a connection portion.

Conventionally removed are all regions of the insulation board except for the region where the coil portion 300 is formed. However, in this exemplary embodiment of the present disclosure, it is possible not to remove one region of the board, where the coil pattern 320 is not formed, to form the connection portion, thereby increasing a force to support the coil pattern 320, which may minimize deformation of the coil pattern 320 when stacking and compressing the magnetic composite sheet.

An insulating layer 400 covering the coil pattern 320 may be formed on a surface of the coil pattern 320. The insulating layer 400 may be formed by using a method such as a screen printing method, a spray application process, a vacuum dipping process, a vapor deposition method (CVD) or a film lamination method, and is not limited thereto.

In addition, although not shown, the coil pattern 320 may be a wound coil covered by an insulating film and formed by a winding method. Here, the coil pattern 320 may be formed by forming a mold portion instead of the insulation board, and the insulation board may be removed after forming the wound coil pattern by using the insulation board, and is not limited thereto. Here, a method of forming the wound coil pattern may be the same as a known method.

Next, the body 100 may be formed by stacking a magnetic sheet 20 on the insulation board.

The body 100 may be formed by stacking the magnetic sheet 20 on each of two sides of the insulation board and compressing the same by using a lamination method or a hydrostatic press method.

The magnetic sheet 20 may be formed by molding a magnetic material-resin composite in a sheet shape, and may be compressed in a semi-cured state. The magnetic material-resin composite may be a mixture of magnetic metal powder particles and a resin mixture. Here, the magnetic metal powder particles may mainly include iron (Fe), chromium (Cr) or silicon (Si), and the resin mixture may include epoxy, polyimide, liquid crystal polymer (LCP) or a mixture thereof, and are not limited thereto. An empty space in a space 111 processed by the compression of the first magnetic sheet 20 may be filled with a magnetic material such as the magnetic material-resin composite. When a curing process is performed as a subsequent process, it is possible to prevent a coil 120 disposed at a predetermined position from being misaligned and to control deformation of the bar caused by movement of the sheet.

Here, a core portion 300 may be formed when at least a portion of the magnetic sheet 20 fills the through-hole formed in the central region of the insulation board.

In addition, referring to FIG. 7B, at least one groove portion GV may be disposed in one surface of the magnetic sheet 20 to correspond to an individual coil component in the coil bar on each of the upper and lower portion of which the magnetic sheet 20 is stacked. Here, the groove portion GV may be formed at a point where a plurality of routing lines intersect each other among routing lines 30 of the coil bar described below.

In more detail, the groove portion GV formed in one surface of the magnetic sheet 20 may be disposed at an intersection of the routing lines 30, and may be formed in four individual coil components. In addition, the groove portion GV may be embedded in the body 100 to expose at least a portion of the lead-out portion 200, and have a diameter smaller from the one surface of the magnetic sheet 20 in a thickness (T) direction.

The groove portion GV may be formed in the four individual coil components and have the tapered shape before being diced, and it is thus possible to reduce loss of the body 100 including the magnetic material, and to reduce occurrence of defective products by exposing the lead-out portion 200.

Finally referring to FIG. 7C, diced are the insulation board and the magnetic sheet stacked on each of the two sides thereof along a boundary between the plurality of processed spaces, i.e., routing line 30. The dicing may be performed based on a size designed in advance, and as a result, an individual coil component 10 may be provided. The individual coil components 10 may be provided when the dicing is performed using a dicing equipment or another dicing method such as a blade or a laser.

Meanwhile, the individual coil component 10 may not include the insulation board and/or a fixing frame (not shown) after the dicing is performed when the insulation board and/or the fixing frame (not shown) is designed to be smaller than a region (i.e., dicing-kerf region) that is cut off by a width of the dicing blade or the like. That is, the insulation board and/or the fixing frame (not shown) are provided for stably seating the coil, and may thus remain or may not remain in the final coil component. However, in order to improve accuracy in fixedly positioning the coil portion 300, some portions of the insulation board and/or the fixing frame (not shown) may remain in the coil portion 300 when the insulation board is significantly close to the coil portion 300.

Although not shown in the drawings, a polishing process may be performed to polish corners of the individual coil component 10 after the dicing process. The body 100 of the coil component 10 may be made into a round shape by the polishing process, and conventionally, an insulating material may be additionally printed on a surface of the body 100 to prevent its plating. The insulating layer formed here may include at least one of a glass-based material including silicon (Si), an insulating resin and plasma.

Next, the body 100 may be formed in a shape similar or identical to a hexahedral shape by applying a plating layer 600 and an insulating material 700 to the individual coil component 10. Here, the plating layer 600 may be in contact with at least a portion of the lead-out portion 200 exposed to the groove portion GV.

In addition, the coil component 10 according to the present disclosure may be formed by including first and second external electrodes 501 and 502 disposed on one surface 100A of the body, while being spaced apart from each other, and in contact with at least a portion of the plating layer 600, and the present disclosure is not limited thereto.

Descriptions of the other components are substantially the same as those described above, and detailed descriptions thereof are thus omitted.

In the present specification, an expression that a component is disposed on another component is not intended to set a direction. Accordingly, the expression that the component is disposed on another component may indicate that the component is disposed on an upper side of another component, or disposed on a lower side of another component.

In the present specification, terms such as an upper surface, a lower surface, an upper side, a lower side, an uppermost side, a lowermost side and the like indicate directions set based on the drawings for convenience of description. Therefore, depending on the set directions, the upper surface, the lower surface, the upper side, the lower side, the uppermost side, the lowest side and the like may be described with different terms.

A meaning that a component is connected to another component herein conceptually includes not only a direct connection between two components but also their indirect connection through a third component. In addition, a term “electrically connected” conceptually includes a physical connection and a physical disconnection.

In the present specification, terms such as “first” and “second” are used to distinguish one component from another component, and do not limit a sequence, importance and the like of the corresponding components. In some cases, a first component may be named a second component and a second component may also be similarly named a first component, without departing from the scope of the present disclosure.

The term “an exemplary embodiment” used herein does not refer to the same exemplary embodiment, and is provided to emphasize a particular feature different from that of another exemplary embodiment. However, exemplary embodiments provided herein may be implemented by being combined in whole or in part one with one another. For example, one element described in a particular exemplary embodiment may be understood as a description related to another exemplary embodiment even if it is not described in another exemplary embodiment, unless an opposite or contradictory description is provided therein.

Terms used herein are used only in order to describe an exemplary embodiment rather than limiting the present disclosure. In this case, singular forms include plural forms unless interpreted otherwise in context.

As set forth above, according to the exemplary embodiments of the present disclosure, it is possible to provide the coil component which may be mounted on the board including the microcircuit pattern.

According to the exemplary embodiments of the present disclosure, it is also possible to provide the coil component including the coil with the less loss of the magnetic metal.

While exemplary embodiments have been shown and described above, it will be apparent to those skilled in the art that modifications and variations could be made without departing from the scope of the present disclosure as defined by the appended claims.

What is claimed is:

1. A coil component comprising:
a body including one surface and a plurality of side surfaces respectively connected to the one surface;
a coil portion disposed within the body; and
a lead-out portion disposed within the body and connected to the coil portion,
wherein the body includes a groove portion disposed in a corner where two adjacent side surfaces of the plurality of side surfaces of the body are in contact with each other, the groove portion having a width narrower than a width of the body and extending from a portion of the lead-out portion.

2. The coil component of claim 1, wherein the groove portion includes a first region disposed in the one surface of the body and a second region having a greatest distance from the one surface of the body in a thickness direction, and
the first region of the groove portion has a size larger than a size of the second region of the groove portion.

3. The coil component of claim 1, wherein the groove portion has a tapered shape in a direction away from the one surface of the body.

4. The coil component of claim 1, wherein the groove portion has a truncated cone shape.

5. The coil component of claim 1, further comprising a plating layer disposed on at least a portion of each of the one surface and a surface of the groove portion of the body and being in contact with at least a portion of the lead-out portion.

6. The coil component of claim 5, further comprising an external electrode in contact with at least a portion of the plating layer, and disposed on the one surface of the body.

7. The coil component of claim 5, further comprising an insulating material disposed in the groove portion and in contact with at least a portion of the plating layer.

8. The coil component of claim 7, wherein the insulating material is extended to at least one of the plurality of side surfaces of the body.

9. The coil component of claim 1, wherein the plurality of side surfaces of the body include first to fourth side surfaces, and
the groove portion includes first and second groove portions respectively disposed in two opposite ends of the second side surface of the body in a length direction, while being spaced apart from each other, and respectively extended to the first and third side surfaces of the body, adjacent to the second side surface.

10. The coil component of claim 1, wherein the plurality of side surfaces of the body include first to fourth side surfaces,
the groove portion includes a third groove portion extended to the first and second side surfaces of the body, adjacent to each other, and a fourth groove portion extended to the third and fourth side surfaces of the body, adjacent to each other, and
the third and fourth groove portions are spaced apart from each other.

11. The coil component of claim 1, wherein the groove portion has a length shorter than a length of the body, based on a thickness direction.

12. The coil component of claim 11, further comprising an insulating layer covering the coil portion,
wherein at least a portion of the insulating layer is exposed to the groove portion.

13. The coil component of claim 1, wherein the coil portion includes a board and a coil pattern disposed on each of one surface and the other surface of the board.

14. The coil component of claim 1, wherein the coil portion is a wound-type coil.

15. The coil component of claim 1, wherein the lead-out portion includes a connection portion in contact with at least a portion of the one surface of the body.

16. A manufacturing method of a coil component, the method comprising:
forming a coil bar on which a magnetic sheet covering each of a coil portion and a lead-out portion connected to each other is stacked;
forming at least one groove portion in one surface of the coil bar; and
preparing a body including one surface and the other surface opposing each other in a thickness direction by routing the coil bar along a plurality of routing lines to expose at least a portion of the lead-out portion,
wherein the groove portion is formed in a region where the plurality of routing lines intersect each other.

17. The method of claim 16, wherein the groove portion includes a first region formed in the one surface of the body and a second region having a greatest distance from the one surface of the body in the thickness direction, and
the first region of the groove portion has a size larger than a size of the second region of the groove portion.

18. The method of claim 16, further comprising:
forming a plating layer in contact with the lead-out portion, on at least a portion of each of the one surface and the groove portion of the body; and
forming an insulating material in contact with at least a portion of the plating layer, in the groove portion.

19. The method of claim 16, wherein in the forming of the groove portion, the groove portion has a length in the thickness direction shorter than a length of the coil bar in the thickness direction.

20. A coil component comprising:
a body including one surface and a plurality of side surfaces respectively connected to the one surface;
a coil portion disposed within the body;
a lead-out portion disposed within the body and connected to the coil portion; and
an external electrode disposed on the body,
wherein the body includes a groove portion extending from the one surface and one or more of the plurality of side surfaces to a portion of the lead-out portion,
the groove portion has a width narrower than a width of the body and is filled with an insulating material, and
the external electrode is connected to the lead-out portion through a conductive layer disposed on a surface of the groove portion and connected to the lead-out portion.

21. The coil component of claim 20, wherein the insulating material disposed in the groove portion is different from a material of the body.

22. The coil component of claim 20, wherein the conducive layer is disposed between the insulating material and the body.

23. The coil component of claim 20, wherein the groove portion has a tapered shape in a direction away from the one surface of the body.

24. The coil component of claim 20, wherein the insulating material is extended to at least one of the plurality of side surfaces of the body.

25. The coil component of claim 20, wherein the groove portion is disposed at one of corners of the body.
